(19) United States
(12) Patent Application Publication
(10) Pub. No.: US 2015/0120504 A1
(43) Pub. Date: Apr. 30, 2015

(54) SYSTEMS AND METHODS FOR COMPLETION OF ITEM DELIVERY AND TRANSACTIONS USING A MOBILE BEACON

(71) Applicant: Michael Todasco, Santa Clara, CA (US)

(72) Inventor: Michael Todasco, Santa Clara, CA (US)

(21) Appl. No.: 14/154,414

(22) Filed: Jan. 14, 2014

Related U.S. Application Data
(60) Provisional application No. 61/895,926, filed on Oct. 25, 2013.

(51) Int. Cl. G06Q 30/06; G06Q 20/32; H04W 76/02; H04W 4/02

(52) U.S. Cl. CPC G06Q 30/0623; H04W 4/02; G06Q 20/322; H04W 76/02
USPC 705/26.61; 455/456.2; 705/39

(57) ABSTRACT

There is provided systems and method for completion of item delivery and transactions using a mobile beacon. A mobile beacon may use short range wireless communications, such as Bluetooth Low Energy, and a wireless communication link with a merchant at a main merchant location. Thus, a mobile merchant for a merchant in a remote location, such as a delivery man, delivery drone, or concession salesperson, may bring the mobile beacon during a sale. The mobile beacon may transmit a request to establish a connection with the merchant to a user device, such as a check-in process. The connection may correspond to a payment made to the merchant based on the service being provided. Additionally, the request may be specific to a user and include an alert of the mobile merchant's proximity. In other embodiments, a list of nearby mobile merchants may be presented to the user.

### CROSS-REFERENCE TO RELATED APPLICATIONS

Pursuant to 35 U.S.C. §119(e), this application claims priority to the filing date of U.S. Provisional Patent Application Ser. No. 61/895,926, filed Oct. 25, 2013, which is incorporated by reference in its entirety.

### TECHNICAL FIELD

The present application generally relates to completion of item delivery and transactions using a mobile beacon and more specifically to a mobile beacon enabling user device check-in with a merchant and/or payment provider to complete sales transactions.

### BACKGROUND

Consumers may desire purchases from mobile service providers, such as a delivery merchant, a concession merchant at a venue, or other service provider offering delivery services of an item/service. Some consumers may be required to seek out the mobile service provider in order to be able to purchase items. However, the consumer is required to find the merchant, which may be difficult at crowded venues. Additionally, the consumer is required to retain a monetary payment in most eases, or the mobile merchant must provide some payment means with the mobile merchant, which may be unfeasible in the case of credit/debit cards and/or online payments. Similarly, mobile merchants attempting to sell items/services generally rely on consumers seeing the mobile merchant when they desire the items/services the mobile merchant is selling. Thus, the mobile merchant may not come into contact with potential buyers and may suffer a lack of sales. Some mobile merchants may enable consumers to go to a website corresponding to the mobile merchant to request the item/service and perform and online payment. Thus, the user is required to stay at one location until the mobile merchant arrives with the requested item/service.

### BRIEF DESCRIPTION OF THE DRAWINGS

FIG. 1 is a block diagram of a networked system suitable for implementing the process described herein, according to an embodiment;

FIG. 2 is an exemplary system environment including a mobile beacon with a mobile merchant for completing a check-in and transaction with a user device, according to an embodiment;

FIG. 3 is a flowchart of an exemplary process by a mobile beacon to complete user check-in with a merchant for completion of item transactions, according to an embodiment; and

FIG. 4 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Various entities may provide short range wireless communications with a user device, such as through Bluetooth Low Energy (BLE) beacon communications. These beacons may be set up to communicate with the user device and alert users of check-in services through their user device. A check-in service may be any service used to associate a user with a location having the BLE beacon and providing other services to the user. The beacons may provide additional functionality, such establishing a connection with a server entity to complete transactions, including check-in services. The beacons may provide communication services to the user device directly, including information stored on the beacons. The beacons may also provide communication with a device attached to the beacon and/or server communicating with the beacon. The beacons may also be made mobile my providing a communication module with the beacon configured to communicate over a network with a centralized server for a service provider, such as over the Internet.

A service provider may offer mobile services including delivery services for a merchant storefront, drone delivery using an unmanned vehicle (e.g., an unmanned land or aerial vehicle for delivery of objects), concession salespeople, and/or other mobile merchants for a remote merchant location. The mobile service provider may then be dispatched to the user's location, such as an unmanned drone travelling to the user for delivery on an item. A consumer may engage the service provider, for example, through an online shopping website/purchase form. However, in other embodiments, the user may not know the mobile service provider is nearby and instead may be informed of the presence of mobile service providers in proximity to the consumer through a mobile device application after detecting a mobile beacon. The mobile service provider may possess a mobile beacon, which may include two communication channels. The first communication channel may correspond to a Bluetooth Low Energy communication channel enabling the mobile beacon to continuously broadcast a request to establish a communication channel between a mobile user device and the remote service provider. The request may include service information, including a service provider name, available items/services, location, etc., which may be displayable to the consumer on the user device. Additionally, the request may include a token for the service provider/remote beacon including a service provider/mobile beacon identifier, where the token may be encrypted using a private key of the service provider/remote beacon.

The consumer's user device includes an application passively monitoring BLE communications. In various embodiments, the application may be configured to passively monitor for any BLE communication, or only for specific tokens corresponding to the service provider/mobile beacon. Additionally, the token may be made specific to the user device using a user identifier for the consumer. When the user device receives the BLE request from the mobile beacon, the application may confirm the request is from the service provider by either checking the service information and/or checking the token including decrypting the token using a public key of the service provider/mobile beacon. If the application picks up a BLE communication from the service provider, the application may complete a connection with the service provider through the mobile beacon. For example, the user device may ramp up in power and transmit a user identifier to the mobile beacon. In various embodiments, the user device may encrypt a user token with the user identifier and transmit the data to the mobile beacon. The user device may respond with the received token in the user token to inform the mobile beacon that the mobile beacon is communicating with the correct user device.

The mobile beacon may then engage the service provider using the second communication channel. The second communication channel may correspond to a mobile Internet connection channel. The service provider may utilize the user identifier in the use token to complete a “check-in” with the service provider. Additionally, the service provider may identify the user with the mobile beacon used to check-in the user. In certain embodiments, a mobile service provider corresponding to the mobile beacon may correspond to a vendor or concessions salesperson at a venue. Thus, the request transmitted from the mobile beacon to establish the check-in may include the mobile service provider in proximity to the user and information for the mobile service provider (e.g., a menu, available items/services, etc.). In other embodiments, the mobile service provider may correspond to a delivery salesperson. The user may be alerted to the presence of the mobile service provider through the request or after the communication is established with the remote service provider. For example, the user may be alerted when the drone arrives using the mobile beacon, and thus pick-up/drop of an item on detection of the user device using the mobile beacon. If the item has not been paid for, detection of the user device may include payment for the item prior to the drone dropping the item off with the user. Thus, the user may complete a transaction with the mobile service provider.

In various embodiments, a consumer may set up an account with a payment service provider. The payment provider may include information to complete payments or other transaction (e.g. money transfers). Additionally, the user account may include the user identifier or other identifiers for the consumer. For example, the consumer may install a payment application or other financial application on the user device and transmit consumer information and/or user identifiers to the payment provider. In some embodiments, a consumer may not possess an account with a credit provider and, therefore, the payment provider may be chosen by the remote service provider during completion of a transaction. After establishment of the connection between the user device and the remote service provider, the remote service provider may generate a payment token using the user identifier or other consumer identifier and payment information for the service provider (i.e. amount, service provider name, terms, etc.). The payment token may be passed to the service provider and/or payment provider for use in completing the transaction.

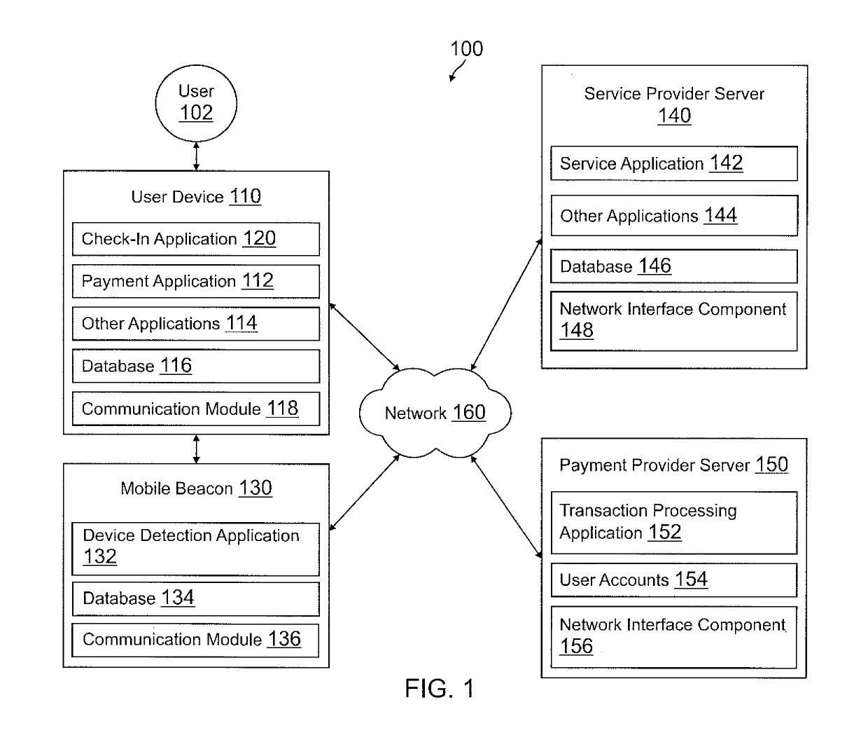

FIG. 1 is a block diagram of a networked system 100 suitable for implementing the process described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a mobile beacon 130, a service provider server 140, and a payment provider server 150 in communication over a network 160. User 102, such as a consumer, may utilize user device 110 to check-in to service provider server 140 through mobile beacon 130 and/or over network 160. Mobile beacon 130 may transmit short range wireless communications receivable by user device 110. The short range wireless communication may correspond to a request to establish a connection between user device 110 and mobile beacon 130. The request may further include service information for service provider server 140 and/or a mobile service provider corresponding to mobile beacon 130. After establishment of the connection, a user identifier for user 102 may be transmitted to service provider server 140. Check-in information can be processed corresponding to a check-in between user device 110 and service provider server 140, where the check-in information can comprise requests for payments to service provider server 140, requests for a mobile service provider of service provider server 140, etc.

User device 110, mobile beacon 130, service provider server 140, and payment provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented using any appropriate hardware and software configured for wired and/or wireless communication with mobile beacon 130, service provider server 140, and/or payment provider server 150. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOGGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a check-in application 120, a payment application 112, other applications 114, a database 116, and a communication module 118. Check-in application 120, payment application 112, and other applications 114 may correspond to processes, procedures, and/or applications executable by a hardware processor, for example, a software program. In other embodiments, user device 110 may include additional or different software as required.

Check-in application 120 may be used by user 102 of user device 110 to establish a connection between user device 110 and service provider server 140. Check-in application 120 may correspond to a specific application utilized by user device 110 with service provider server 140 to complete a check-in with service provider server 140. The check-in with service provider server 140 may correspond to a process to log in to a user account of user 102 with service provider server 140. In other embodiments, the check-in may provide and/or verify identity of user 102, including transmission of an identifier for user 102 and/or user device 110. The check-in may be completed over network 160 with service provider server 140. In such embodiments, check-in application 120 may correspond more generally to a browser application configured to communicate with service provider server 140. For example, check-in application 120 may establish an initial check-in with service provider server 140 to purchase and/or request items for delivery to user 102 using a mobile service provider for service provider server 140. Thus, the check-in may be completed prior to user device 110 connecting to mobile beacon 130.

Check-in application 120 may also correspond to an application available over the Internet for download from service provider server 140, another server corresponding to service provider server 140 (e.g., an online application marketplace), and/or payment provider server 150. Check-in application 120 may be set up to receive short range wireless communications with mobile beacon 130 to complete a check-in process. For example, mobile beacon 130 may communicate with user device 110 and complete the check-in process with service provider server 140. Mobile beacon 130 may be configured to transmit an identifier for reception by user device 110, as will be explained in more detail herein.

Check-in application 120 may execute in the background of an operating system of user device 110 and be configured to establish connections, using communication module 118 of user device 110, with mobile beacon 130. The connection may be established with or without user input from user 102. For example, mobile beacon 130 may broadcast a token, including a universally unique identifier (UUID), for reception by check-in application 120, as will be explained in more detail herein. Check-in application 120 may utilize communication module 118 of user device 110 to receive the token from mobile beacon 130. If check-in application 120 acknowledges the UUID as identifying mobile beacon 130 and/or service provider server 140, check-in application 120 may transmit an identifier corresponding to user 102 and/or user device 110 back to mobile beacon 130. Check-in application 120 may utilize communication module 118 of user device 110 to communicate with mobile beacon 130 (e.g., over near field communication, Bluetooth, Bluetooth Low Energy, radio, infrared, or other connection). The identifier from user device 110 may include, be transmitted with, concatenated with, or otherwise bundled with the identifier received from mobile beacon 130. Identifiers may be transmitted as an encrypted token using public/private key(s) of user device 110, mobile beacon 130, and/or service provider server 140. Additionally, tokens may include a received identifier from the intended recipient of the token in addition to the transmitted identifier in order to identify the token's intended recipient.

Once check-in application 120 has completed a connection with service provider server 140, user device 110 may be checked-in with service provider server 140 if user 102 has not previously been checked-in. The check-in process may then associate user 102 with mobile beacon 130 used to check-in user 102. Check-in application 120 may receive additional information from service provider server 140. The additional information may correspond to a bill for an item available from a mobile service provider possessing mobile beacon 130. For example, the additional information may correspond to an item being delivered to user 102 by the mobile service provider, for example, a food delivery. In other embodiments, the additional information may correspond to items available with the mobile service provider, for example, a concessions salesperson. In certain embodiments, check-in application 120 may receive the information as part of the initial token from the mobile beacon 130, such as lists of available items/service, a notification a mobile service provider corresponding to mobile beacon 130 is nearby, etc. For example, the initial token may include a name of the nearby mobile service provider, the bill for the items/services requested from service provider server 140, a general message welcoming a user to a location, store, or mobile service provider location, and/or a list of items available with the mobile service provider. Check-in application 120 may display this information prior to or after establishing a connection with service provider server 140. Thus, check-in application 120 may alert user 102 and/or display the information to user 102.

Check-in application 120 may also pass information to service provider server 140, such as a request to purchase an item from the mobile service provider and/or a “vote” or a request for the mobile service provider at a location of user 102. In certain embodiments, check-in application 120 may pass information to a mobile service provider through mobile beacon 130. For example, a mobile service provider equipped with mobile beacon 130 may pass customers (including user 102) utilizing check-in application 120. Check-in application 120 may select a notification to alert the mobile service provider that user 102 would like to purchase an item from the mobile service provider. The mobile service provider may then use mobile beacon 130 to view customers desiring to purchase items. The mobile service provider can stop at each potential customer, or may view a largest congregation of customer and set up sales there (e.g. a food truck may pull into a space with the largest number of waiting customers). In certain embodiments, check-in application 120 of user device 110 may utilize short range wireless communication of user device 110 with mobile beacon 130, such as near field communication, Bluetooth, Bluetooth Low Energy, radio, infrared, or other connection.

Check-in application 120 may utilize communication module 118 to pass information to service provider server 140 and/or payment provider server 150 over network 160 as well. For example, once a check-in is completed through mobile beacon 130, check-in application 120 may pass information to service provider server 140 and/or payment provider server 150 to complete a transaction. In certain embodiments, the information may correspond to a location of user device 110, thus proving that user 102 is at the address and will be the one to receive a delivered item (not, for example, a next door neighbor where the delivery man has accidently arrived at). Check-in application 120 may also pass preferences for a type or a specific mobile service provider and/or other user preferences. The preference may be utilized by service provider server 140 to determine a mobile service provider to send to user 102.

Payment application 112 may be used, for example, to provide a convenient interface to permit user 102 to select payment options and provide payment for items and/or services. For example, payment application 112 may be implemented as an application having a user interface enabling the user to enter payment options for storage by user device 110, provide payment options on checkout/payment of an item/service, and complete a transaction for the item/service. In some embodiments, payment application 112 may correspond more generally to a web browser configured to view information available over the Internet or access a website corresponding to a payment application. Payment application 112 may utilize user financial information, such as a credit card, bank account, or other financial account. Additionally, payment application 112 may provide payment for items using a user account with payment provider, such as payment provider server 150.

Once user 102 has checked-in with service provider server 140, user device 110 may establish a connection with service provider server 140 and/or payment provider server 150. Payment application 112 may then populate payment information for a transaction transmitted to user device 110 from mobile beacon 130 and/or service provider server 140. For example, payment application 112 may populate a bill received from mobile beacon 130, or may include a list of items available with service provider server 140 and/or a mobile service provider corresponding to mobile beacon 130.

Payment application 112 may be utilized to facilitate creation of a payment token with service provider server 140. The payment token may be transmitted by payment application 112 and/or service provider server 140 to payment provider server 150. Thus, payment provider server 150 may provide payment for the payment token to service provider server 140. The payment token may include payment information (e.g. a user account or credit card) from payment application and a service provider payment request, for example, a bill. Payment application 112 may then be used to generate a purchase request for the bill/items/services and to complete a transaction.

Payment can be provided from payment provider server 150, for example, though a payment account of user 102 with payment provider server 150, or through user financial information stored/input to payment application 112. In various embodiments, the server completing the payment may transmit a transaction history documenting completion of the transaction. The transaction history may be transmitted to user device 110, mobile beacon 130, and/or service provider server 140. Payment application 112 may further include options to store transaction history for purchased items such as receipts, for later use. Thus, payment application 112 may provide an interface enabling user 102 to provide proof of payment to a mobile service provider.

In various embodiments, check-in application 120 and/or payment application 112 may be incorporated in the same application so as to provide their respective features in one convenient application interface.

In various embodiments, user device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include financial applications, such as banking, online payments, money transfer, or other applications associated with payment provider server 150. Other applications 114 may contain software programs, executable by a processor, including a graphical user interface (GUI) configured to provide an interface to the user.

User device 110 may further include database 116 which may include, for example, identifiers such as operating system registry entries, cookies associated with check-in application 120, payment application 112, and/or other applications 114, identifiers associated with hardware of user device 110, or other appropriate identifiers, such as identifiers used for payment/user/device authentication or identification. Database 116 may include user device tokens and/or encryption keys, including a public key of service provider server 140. Database 116 may include identifying information for service provider tokens enabling check-in application 120 to identify service provider server 140 when receiving a corresponding token. In one embodiment, identifiers in database 116 may be used by a payment/credit provider, such as payment provider server 150, to associate user device 110 with a particular account maintained by the payment/credit provider. Database 116 may further include data to access user information. In various embodiments, database 116 may include information to access user information including online account access information.

In various embodiments, user device 110 includes at least one communication module 118 adapted to communicate with mobile beacon 130, service provider server 140 and/or payment provider server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with mobile beacon 130 without network 160.

Mobile beacon 130 may be maintained, for example, by a remote service provider from mobile beacon 130. In various embodiments, mobile beacon 130 corresponds to a mobile service provider that may carry mobile beacon 130 at locations distant from the service provider. Thus, mobile beacon 130 may correspond to a delivery person, a concessions salesperson, an unmanned drone, or other mobile service provider. The delivery person/unmanned drone may act as a delivery entity for items purchased with service provider server 140. Mobile beacon 130 may be implemented using any appropriate hardware and software configured for wireless communication with user device 110 and service provider server 140. For example, in one embodiment, mobile beacon 130 may be implemented as a dongle device including a hardware processor and a communication module. Mobile beacon 130 may also be implemented as a device incorporated within a personal computer (PC), a smart phone, personal digital assistant (PDA), laptop computer, unmanned drone mechanical and operating system, and/or other types of computing devices capable of transmitting and/or receiving data, such as an IPAD® from APPLE®. Although a single mobile beacon is shown, a plurality of mobile beacons may be utilized.

Mobile beacon 130 of FIG. 1 contains a device detection application 132, a database 134, and a communication module 136. Device detection application 132 may correspond to processes, procedures, and/or applications executable by a hardware processor, for example, a software program. In other embodiments, mobile beacon 130 may include additional or different software as required.

Device detection application 132 may correspond to an application for transmitting requests to establish a connection between a user device and a service provider. As previously discussed, device detection application 132 may utilize a short range wireless communication of mobile beacon 130 (e.g., BLE communication protocol) to transmits requests to establish a connection with user device 110. The request to establish the communication may be an identifier for mobile beacon 130 and/or service provider server 140. Additionally, the request may correspond to an encrypted token including the identifier. The token may further include service information for service provider server 140 and/or a mobile service provider corresponding to mobile beacon 130. If user device 110 receives the request to establish the connection and responds with a user identifier (or a token including the user identifier and the identifier transmitted by mobile beacon 130), device detection application 132 may increase power to other communication modules/protocols and create a connection between user device 110 and service provider server 140 through mobile beacon 130 and/or network 160. Device detection application 132 may transmit the request to establish the connection with service provider server 140 as a short range communication (e.g. a BLE protocol communication) including a “wake up” process for check-in application 120. The request may be specific to user device 110 by including information from service provider server 140 that is specific to user 102, such as a name, address, or identifier. Thus, user device 110 only will pick up and authenticate the request based on the personal information in the token.

After device detection application 132 receives a user identifier from user device 110, device detection application 132 utilizes a wireless communication channel with service provider server 140 to complete the connection. Device detection application 132 may initiate communication with service provider server 140 using a wireless Internet connection with service provider server 140. Device detection application 132 may pass the user identifier to service provider server 140 to complete the connection with service provider server 140. Additionally, device detection application 132 may keep a communication channel open between user device 110 and service provider server 140 through mobile beacon 130 and/or network 160 by passing additionally information, such as item, transaction, payment, or identification information.

Mobile beacon 130 may further include database 134 including, for example, identifiers such as operating system registry entries, cookies associated with device detection application 132, identifiers associated with mobile beacon 130 and/or service provider server 140, or other appropriate identifiers. In one embodiment, Database 134 may include service information for service provider server 140 and/or a mobile service provider corresponding to mobile beacon 130.

In various embodiments, mobile beacon 130 includes at least one communication module 136 adapted to communicate with user device 110 and/or service provider server 140 over network 160. In various embodiments, communication module 136 may include a DSL (e.g., Digital. Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 136 may communicate directly with user device 110 without network 160.

Service provider server 140 may be maintained, for example, by a service provider or seller offering various items, products, and/or services through a service provider location. Generally, service provider server 140 may be maintained by anyone or any entity that receives money, which includes charities as well as retailers and restaurants. In this regard, service provider server 140 may include processing applications, which may be configured to interact with user device 110 and/or payment provider server 150 to facilitate the sale of products, goods, and/or services. Additionally, service provider server 140 corresponds to an entity providing one or more mobile beacons 130 for use with a mobile service provider providing check-in, item/service purchase, and/or payment services to user 102.

Service provider server 140 may be implemented using any appropriate hardware and software configured for wired and/or wireless communication with user device 110, mobile beacon 130, and/or payment provider server 150. For example, in one embodiment, service provider server 140 may be implemented as a single or networked personal computer (PC), a smart phone, personal digital assistant (PDA), laptop computer, and/or other types of computing devices at a merchant location capable of transmitting and/or receiving data. Although a service provider device is shown, the service provider device may be managed or controlled by any suitable processing device. Although only one service provider device is shown, a plurality of service provider devices may be utilized.

Service provider server 140 includes a service application 142, other applications 144, a database 146, and a network interface component 148. Service application 142 may correspond to processes, procedures, and/or applications executable by a hardware processor, for example, a software program. In other embodiments, service provider server 140 may include additional or different software as required

Service application 142 may correspond to processes and/or procedures to complete a sale to user 102 including a check-in feature, transmission of sale information to user device 110 and/or mobile beacon 130, and completion of a sale with user device 110, using payment provider server 150 in various embodiments.

Thus, service application 142 may correspond to the server side application of service provider server 140 configured to transmit and/or receive a check-in information for user device 110 and process the check-in information. The check-in information may be received from user device 110 and/or mobile beacon 130 over network 160. The check-in request may include log in information for a user account in database 146 and thus complete the check-in with user 102 by verifying the account information. However, in embodiments where a user account has not been previously established by user 102 and/or service provider server 140 does not offer user account services, service application 142 may receive other information for identifying user 102, include user name/identifier, user device identifier, an identifier for an account with another server (e.g., a payment account/payment account identifier with payment provider server 160), or other information.

Once check-in is completed between user device 110 and service provider server 140, service application 142 may be utilized to transmit and receive information corresponding to service provider server 140. Service application 142 may transmit service provider identifiers, encryption keys, and/or tokens to mobile beacon 130, including service provider public/private keys for encryption of the tokens. In various embodiments, service application 142 may complete encryption of the service provider tokens and transmit the tokens for storage by mobile beacon 130. Service application 142 may also transmit service information to mobile beacon 130 for storage and transmission to user device 110.

Once mobile beacon 130 receives a user identifier and transmits the user identifier to service provider server 140, service application 142 may complete a check-in with user device 110. Service application 142 may then transmit information to user device 110 including a bill for requested items/services/goods from service provider server 140 or information of items/services/goods available from a mobile service provider at mobile beacon 130. If user 102 engages in a purchase with service provider server 140, service application 142 may facilitate the creation of a payment token, which may be passed to payment provider server 150 for completion of a payment.

Service application 142 may also receive information from user device 110 and utilize the information to provide a mobile service provider having mobile beacon 130 to user 102. For example, service application 142 may receive preferences from user 102 corresponding to a preference for a particular mobile service provider (e.g., a particular vendor). Thus, service application 142 may send that particular mobile service provider to location of user 102 and may receive check-in information when mobile beacon 130 is in proximity to user device 110. In other embodiments, user device 110 may complete an online order with service application 142, where service application sends a delivery man with mobile beacon 130 to a location for user 102. Thus, when mobile beacon 130 is in proximity to user device 110, payment may be completed and user 102 may meet the delivery man to redeem items/services.

In certain embodiments, service application 142 may complete an online sale with user 102, such as a sale of a food/item delivery. The online sale may be completed using payment provider server 150 by passing the payment token to payment provider server 150. In other embodiments, service application 142 may transmit information for items/goods/foods for sale by the remote service provider corresponding to mobile beacon 130 and thus a prior transaction may not be established. In such examples, mobile beacon 130 may complete the sale for goods at the mobile service provider for mobile beacon 130 and/or with payment provider server 150. For example, mobile beacon 130 may generate the payment token and pass the payment token to payment provider server 150. The payment token may effectuate payment to mobile beacon 130 (or a mobile service provider for mobile beacon 130) and/or service provider server 140.

In various embodiments, service provider server 140 includes other applications 144 as may be desired in particular embodiments to provide features to service provider server 140. For example, other applications 144 may include security applications for implementing server-side security features, programmatic server applications for interfacing with appropriate application programming interfaces (APIs) over network 160, or other types of applications. Other applications 144 may contain software programs, executable by a processor, including a graphical user interface (GUI), configured to provide an interface to a user.

Service provider server 140 further includes database 146 which may include, for example, identifiers such as operating system registry entries, cookies associated with service application 142 and/or other applications 144, identifiers associated with hardware of service provider server 140, or other appropriate identifiers, such as identifiers used for payment/user/device authentication or identification. Database 146 may include service provider tokens, identifiers, and/or encryption keys, including a public/private key of service provider server 140. Database 146 may include user device identifiers stored from previous transactions and/or transmitted to service provider server 140, including identifiers for user device 110 and/or mobile beacon 130. In one embodiment, identifiers in database 146 may be used by a payment/credit provider, such as payment provider server 150, to associate service provider server 140 with a particular account maintained by the payment/credit provider.

In various embodiments, service provider server 140 includes at least one network interface component 148 adapted to communicate with user device 110, mobile beacon 130, and/or payment provider server 150 over network 160. In various embodiments, communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Payment provider server 150 may be maintained, for example, by an online payment service provider, which may provide credit services and/or processing for financial transactions on behalf of a user with a service provider. In this regard, payment provider server 150 includes one or more processing applications which may be configured to interact with user device 110, mobile beacon 130, and/or service provider server 140 to facilitate payment for a transaction. In one example, payment provider server 150 may be provided by PayPal®, Inc. of San Jose, Calif., USA. However, in other embodiments, payment provider server 150 may be maintained by or include a credit provider, financial services provider, financial data provider, and/or other service provider, which may provide payment services to user 102.

Payment provider server 150 of FIG. 1 includes a transaction processing application 152, user accounts 154, and a network interface component 156. Transaction processing application 152 may correspond to processes, procedures, and/or applications executable by a hardware processor, for example, a software program. In other embodiments, payment provider server 150 may include additional or different software as required.

Transaction processing application 152 may be configured to receive and/or transmit information from user device 110 and/or service provider server 140 for processing and completion of financial transactions. Transaction processing application 152 may include one or more applications to process financial transaction information from user device 110 and service provider server 140 by receiving a request to complete a sale transaction for items/services/goods. The request may correspond to a payment token received from user device 110, mobile beacon 130, and/or service provider server 140. The payment token may include a user account identifier or other payment information (e.g. a credit/debit card or checking account). Additionally, the payment token may include a payment amount and terms of payment. Transaction processing application 152 may complete the sale transaction by providing payment to service provider server 140. Additionally, transaction processing application 152 may provide transaction histories, including receipts, to user device 110 and/or service provider server 140 for completion and documentation of the financial transaction.

Additionally, payment provider server 150 may include user accounts 154. As previously discussed, user 102 may establish one or more user accounts with payment provider server 150. User accounts 154 may include user information, such as name, address, birthdate, payment/funding information, additional user financial information, and/or other desired user data. User 102 may link user accounts 154 to user device 110 through a user identifier. Thus, when an identifier corresponding to user 102 and/or user device 110 is transmitted to payment provider server 150, e.g. from user device 110 and/or service provider server 140, a user account belonging to user 102 may be found. However, in other embodiments, user 102 may not have previously established a user account. Thus, payment provider server 150 may complete a transaction based on another user financial account information received from user device 110 mobile beacon 130, and/or service provider server 140.

In various embodiments, payment provider server 150 includes at least one network interface component 156 adapted to communicate with network 160 including user device 110, mobile beacon 130, and/or service provider server 140. In various embodiments, network interface component 156 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

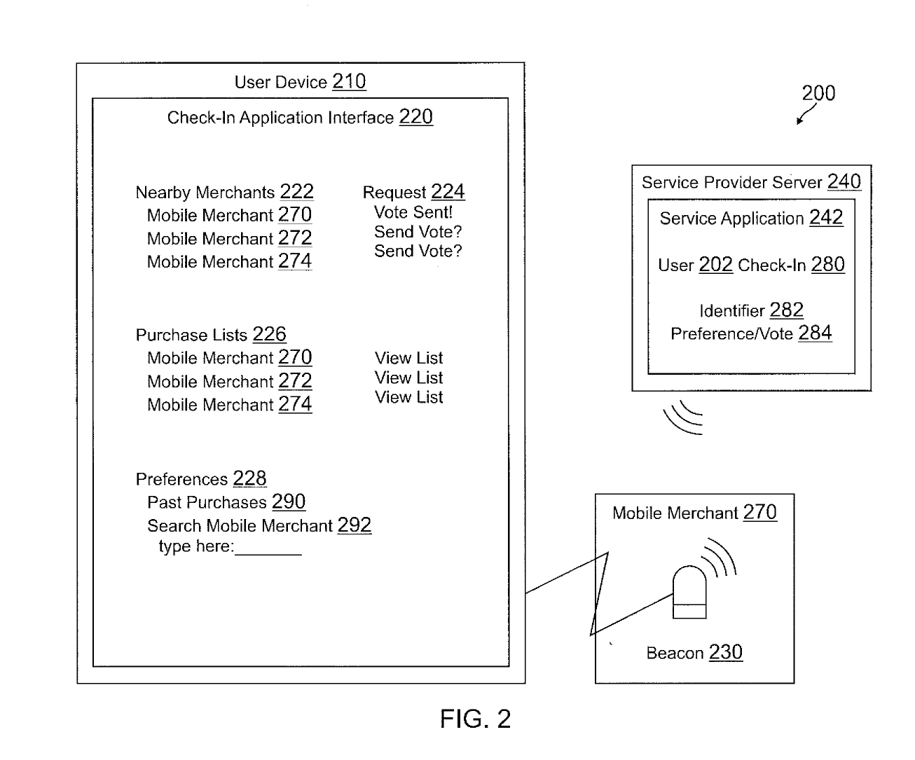

FIG. 2 is an exemplary system environment including a mobile beacon with a mobile service provider for completing a check-in and transaction with a user device, according to an embodiment. Environment 200 of FIG. 2 includes a user device 210 and service provider 240 corresponding generally to user device 110 and service provider, respectively, of FIG. 1. Additionally, check-in application interface 220 and service application 242 correspond generally to the described processes and features of check-in application 120 and service application 142, respectively, of FIG. 1.

Environment 200 of FIG. 2 includes a service provider server 240 in communication with mobile merchant 270 using beacon 230. As previously discussed, mobile merchant 270 may correspond to a mobile service provider offered or associated with service provider server 240. Mobile merchant 270 may correspond to a merchant offering items/services for delivery to a user or for locations remote from service provider server 240 (e.g., remote from a merchant storefront). Thus, mobile merchant 270 may correspond to a delivery person, a merchant offering items/services from mobile merchant 270 (e.g., a food truck, catering merchant, on location service provider, concession salesperson at a venue etc.), or an unmanned drone. The unmanned drone may be a land or air vehicle operated to delivery items without a physical person attending the delivery. The unmanned drone may utilize beacon 230 to check-in and identify user device 210 when in proximity to user device 210, complete a payment for the item/service with the unmanned drone, and/or drop-off/pick-up the item/service. The unmanned drone may further utilize beacon 230 to more accurately located and deliver items/services.

Beacon 230 may be configured to communicate wirelessly over a network with service provider server 240. For example, beacon 230 may communicate with service provider server 240 over the Internet. Service provider server 240 may transmit information to beacon 230 for mobile merchant 270, including item available with service provider server 240, user preferences for users requesting services of mobile merchant 270, a check-in for a user established over a network connection with service provider server 240, and/or purchase orders including item/service delivery using mobile merchant 270. Mobile merchant 270 may receive this information using beacon 230.

Additionally, mobile merchant 270 may communicate information back to service provider server 240. Information may include purchase requests, user identifiers for a check-in, or other information. In FIG. 2, service provider server 240 executes service application 242 to complete a check-in for a user. Thus, service application 242 includes a user 202 check-in 280 corresponding generally to a check in of user 202 (not shown) possessing user device 210. Additionally, user 202 check-in 280 includes an identifier 282 and a preference/vote 280. Identifier 282 may correspond to an identifier for user 202, a user device identifier for a user device 210 of user 202, a user account identifier for user 202 (including a payment account identifier with a payment provider server), and/or other user identifier. Service application 242 may receive the identifiers from a check-in with beacon 230 and/or from a check-in over a network connection between user device 210 and service provider server 240. Service application 242 may then utilize identifier 282 for processing financial transactions. Service application 242 may also transmit identifier 282 to beacon 230 of mobile merchant 270 so that beacon 230 may identify user device 210 on connection with user device 210. Preference/vote 284 may include a user preference for mobile merchant 270 or another mobile merchant, such as a “vote” or request to have mobile merchant 270 visit a location for user 202. In certain embodiments, preference/vote 280 may include information for a general location of user 202 (or user device 210), enabling mobile merchant 270 to locate and establish a connection with user device 210 using mobile beacon 230.

User device 210 executes check-in application interface 220 to complete a check-in with service provider server 240 and/or mobile merchant 270. After transmitting a user identifier corresponding to user device 210 on a connection with beacon 230, check-in application interface 220 may receive information from beacon 230 and/or service application 242. Check-in application interface 220 may display the information to user 202 viewing user device 210. Information displayed to user 202 includes nearby merchants 222, purchase lists 226, and preferences 228. Nearby merchants 222 includes mobile merchant 270, mobile merchant 272 (not shown), and mobile merchant 274 (not shown). Nearby merchants 222 may include merchants in contact with user device 210 using BLE communications with user device 210. For example, mobile merchant 270, mobile merchant 272, and mobile merchant 274 may each include a beacon configured to transmit and receive tokens to establish a connection with user device 210. As shown in FIG. 2, mobile merchant 270 is in communication with user device 210 using beacon 230. Thus, user 202 is able to see a list of merchants in nearby merchants 222 that user 202 may wish to purchase items/services from.

Additionally, nearby merchants 222 includes request 224 feature enabling the selection of a request for a preference (or a vote) for that merchant. Selecting “Send Vote?” may transmit a preference/vote to beacon 230 and/or service provider server 240. The vote enables mobile merchant 270 to determine user 202 of user device 210 would like to purchase items/services from mobile merchant 270. Thus “Vote Sent!” with mobile merchant 270 corresponds to a preference to purchase items/services from mobile merchant 270.

Purchase lists 226 may correspond to item/service lists of available item/services with mobile merchant 270, mobile merchant 272, and mobile merchant 274. Purchase lists 226 may enable user 202 to make decisions about which of nearby merchants 222 to request. Additionally, user 202 may generate purchase requests using purchase lists 226 including generating a purchase token to pass to a payment provider for completion of a transaction.

Check-in application interface 220 includes preferences 228 having past purchases 290 and search field 292. Preferences 228 may be utilized to search for a mobile service provider previously used and to transmit a preference/vote for the mobile service provider. Thus, user 202 may view past purchases 290 including a list of purchases with mobile merchant 270, mobile merchant 272, mobile merchant 274, and/or other mobile merchant, and request one of the mobile merchants. Additionally, user 202 may use search field 292 to type in a name of the mobile merchant and request the mobile merchant using search field 292.

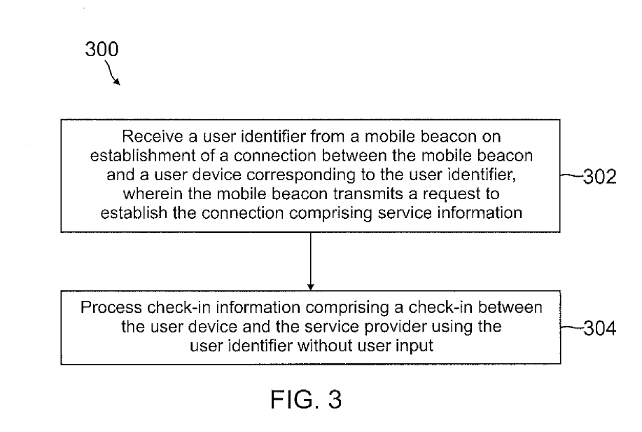

FIG. 3 is a flowchart of an exemplary process by a mobile beacon to complete user check-in with a merchant for completion of item transactions, according to an embodiment. Note that one or more steps, processes, and methods described herein may be omitted, performed in a different sequence, or combined as desired or appropriate.

At step 302, a user identifier is received from a mobile beacon on establishment of a connection between the remote wireless beacon and a user device corresponding to the user identifier, wherein the remote wireless beacon transmits a request to establish the connection comprising service information. The request may include a service provider identifier or token corresponding to the service provider and/or mobile beacon. The token may be encrypted prior to transmission. The request may be transmitted by the mobile beacon using one of near field communication, radio communication, infrared communication, Bluetooth communication, and Bluetooth low energy communication, etc.

In various embodiments, the mobile beacon may correspond to a mobile service provider, such as a delivery person, concession salesperson, or other mobile service provider for a remote service provider. Additionally, the request may further comprise a device alert corresponding to the proximity of the mobile beacon and thus the mobile service provider. The device alert may be displayed to a user through a user device. The alert may only be displayed when loaded in an application of the device, or may “ping” to alert the user when it is received. The request may further include item information, such as an item/service for sale by the service provider and/or mobile merchant in the service information. In certain embodiments, the request to establish the connection may be specific to a user by including user information or other identifying information that only a specific user device will view and authenticate.

Check-in information comprising a check-in between the user device and the service provider using the user identifier is processed without user input, at step 304. The user identifier may be transmitted by the user device to the mobile beacon without user input, for example, passively by an application executing in the background of the user device. The user identifier may identify the user device and/or a user including through a user account. Thus, the user identifier may include a user token, which may be encrypted. The user identifier may return the service provider identifier/token for identification by the mobile beacon that the user device is communicating with the mobile beacon.

A transaction between the user device and the service provider using the check-in information may be processed wherein the transaction comprises a payment for at least one item from the service provider. The transaction may be completed using a payment provider. In other embodiments, a user preferences comprising a preference for a mobile service provider at a location corresponding to a user of the user device may be received, which may be transmitted to the mobile service provider. Thus, the mobile beacon may be located on the mobile service provider, and wherein the mobile service provider receives the user preference and the check-in information from the user device using the mobile beacon. The service information may include information of available items or services with the mobile service provider for purchase by the user when the user device is in communication with the mobile beacon.

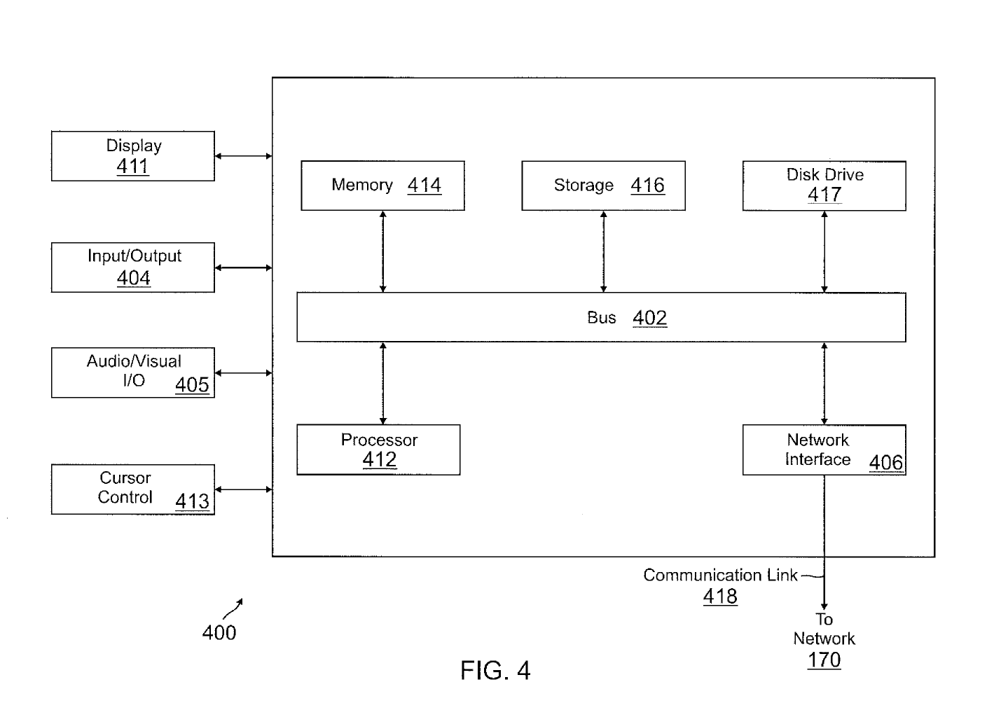

FIG. 4 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant device and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant device, or a service provider server via network 160. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing service provider data comprising service information; and
one or more hardware processors in communication with the non-transitory memory and configured to:
receive a user identifier from a mobile beacon on establishment of a connection between the mobile beacon and a user device corresponding to the user identifier, wherein the mobile beacon transmits a request to establish the connection comprising the service information; and
process check-in information comprising a check-in between the user device and the service provider using the user identifier without user input.

2. The system of claim 1, wherein the request is transmitted by the mobile beacon using one of near field communication, radio communication, infrared communication, Bluetooth communication, and Bluetooth low energy communication.

3. The system of claim 1, wherein the request further comprises a user device alert corresponding to a mobile beacon in proximity to the user device, and wherein the service information is displayed on the user device.

4. The system of claim 1, wherein the request further comprises item information for an item for sale by the service provider.

5. The system of claim 1, wherein the one or more hardware processors is further configured to:
process a transaction between the user device and the service provider using the check-in information, wherein the transaction comprises a payment for at least one item from the service provider.

6. The system of claim 5, wherein the transaction is completed using a payment provider.

7. The system of claim 1, wherein the one or more hardware processors is further configured to:
receive a user preferences comprising a preference for a mobile service provider at a location corresponding to a user of the user device; and
transmit the user preference to the mobile service provider.

8. The system of claim 7, wherein the mobile beacon is located on the mobile service provider, and wherein the mobile service provider receives the user preference from the user device using the mobile beacon.

9. The system of claim 1, wherein the mobile beacon corresponds to a mobile service provider, and wherein the service information comprises information of available items or services with the mobile service provider.

10. The system of claim 1, wherein the request to establish the connection is specific to the user device.

11. A method comprising:
receiving a user identifier from a mobile beacon on establishment of a connection between the mobile beacon and a user device corresponding to the user identifier, wherein the mobile beacon transmits a request to establish the connection comprising service information; and
processing, using one or more hardware processors of a server, cheek-in information comprising a check-in between the user device and the service provider using the user identifier without user input.

12. The method of claim 11, wherein the request further comprises a user device alert corresponding to a mobile beacon in proximity to the user device, and wherein the service information is displayed on the user device.

13. The method of claim 11, wherein the request further comprises item information for an item for sale by the service provider.

14. The method of claim 11 further comprising:
processing a transaction between the user device and the service provider using the check-in information, wherein the transaction comprises a payment for at least one item from the service provider

15. The method of claim 14, wherein the transaction is completed using a payment provider.

16. The method of claim 11 further comprising:
receiving a user preferences comprising a preference for a mobile service provider at a location corresponding to a user of the user device; and
transmitting the user preference to the mobile service provider.

17. The method of claim 16, wherein the mobile beacon is located on the mobile service provider, and wherein the mobile service provider receives the user preference from the user device using the mobile beacon.

18. The method of claim 11, wherein the mobile beacon corresponds to a mobile service provider, and wherein the service information comprises information of available items or services with the mobile service provider.

19. The method of claim 11, wherein the request to establish the connection is specific to the user device.

20. A non-transitory computer readable medium comprising a plurality of machine-readable instructions which when executed by one or more processors of a server are adapted to cause the server to perform a method comprising:
receiving a user identifier from a mobile beacon on establishment of a connection between the mobile beacon and a user device corresponding to the user identifier, wherein the mobile beacon transmits a request to establish the connection comprising service information; and
processing, using one or more hardware processors of a server, check-in information comprising a check-in between the user device and the service provider using the user identifier without user input.
